(19) United States
(12) Patent Application Publication
(10) Pub. No.: US 2004/0208785 A1
(43) Pub. Date: Oct. 21, 2004

(54) Analysis element cartridge

(75) Inventors: Yoshihiro Seto, Minamiashigara-shi (JP); Tomoyuki Takiue, Minamiashigara-shi (JP); Tsutomu Tanaka, Minamiashigara-shi (JP); Katsumi Suzuki, Minamiashigara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/756,752

(22) Filed: Jan. 14, 2004

(30) Foreign Application Priority Data
Jan. 14, 2003 (JP) 006009/2003
Jan. 6, 2004 (JP) 001245/2004

(51) Int. Cl. B01L 3/00

(52) U.S. Cl. 422/58; 422/63

(57) ABSTRACT

An analysis element cartridge is provided which simplifies the operations of unpacking a dry analysis element from its package and loading the element into the cartridge. The cartridge houses dry analysis elements for measurement and supplies them to an analysis apparatus. The cartridge includes an element housing chamber, which has an open top that serves as an element charging port. Downwardly extending cutouts are formed it at least two adjacent, and preferably three sides of the element charging port. The cutouts serve as paths for fingers that hold the elements as they are being loaded into the cartridge. The cutouts enable loading of elements which have been held while unpacking it from its package, without re-orienting it between the fingers.

### BACKGROUND OF THE INVENTION

1. Field of the Invention

The present invention relates to an analysis element cartridge which contains therein analysis elements such as calorimetric dry analysis elements and electrolytic dry analysis elements. The analysis elements are set in a biochemical analysis apparatus in which a sample such as blood or urine is spotted thereon and the concentration, ion activity and the like of a specific biochemical component contained in the sample are determined.

2. Description of the Related Art

Traditionally, there have been developed and practically implemented calorimetric dry analysis elements. The analysis elements quantitatively analyze the content of a specific biochemical component or specific solid component contained in a sample liquid by merely spotting a droplet of the sample liquid thereon. Electrolytic dry analysis elements have also been developed, with which the activity of a specific ion contained in a sample liquid can be determined. The biochemical analysis apparatuss using dry analysis elements are used in medical institutions, laboratories and the like owing to their capability of analyzing samples easily and quickly.

The calorimetry method using calorimetric dry analysis elements is as follows: a droplet of a sample liquid is spotted on a dry analysis element; the analysis element is held at a constant temperature for a predetermined time in an incubator so that a coloring reaction (pigment forming reaction) occurs; the optical density of the color formed by the coloring reaction is optically measured by exposing the analysis element to measuring light, containing a wavelength which is pre-selected according to the combination of the component to be analyzed and the reagent contained in the analysis element; and the concentration of the component to be analyzed is determined on the basis of the optical density according to a calibration curve representing the relationship between the concentration of the specific biochemical component and the optical density.

On the other hand, in the potentiometry method using an electrolytic dry analysis element, the activity of a specific ion contained in a sample liquid spotted on an ion selective electrode pair of a dry analysis element is potentiometrically measured instead of measuring the optical density.

In either of colorimetry or potentiometry, the sample liquid is contained in a sample container (e.g., a blood-collecting tube) and set in the analysis apparatus, while a dry analysis element required for the measurement is loaded in the system. The dry analysis element is carried from the loaded position to a spotting section while the sample liquid is delivered by a spotting nozzle from the set position to the spotting section for spotting on the dry analysis element.

In the biochemical analysis apparatus, a plurality of aforementioned dry analysis elements of for measuring the same or different items are contained in a stacked form in analysis element cartridges, and the cartridges are set in a sample tray. Then, a cartridge containing therein desired dry analysis elements is moved to a predetermined element-takeout position by the linear and rotational movement of the sample tray. Thereby the desired dry analysis elements are taken out of this cartridge and conveyed to a spotting section. Examples of such known cartridges include those provided for horizontally moving the lowermost dry analysis element, for example, by a transfer bar, and taking the element out of a take-out port provided in the lower portion of the sidewall (see U.S. Patent Laid-Open Nos. 20020031844 and 20020031844.

Hereinafter, one example of a conventional analysis element cartridge will be described with reference to FIG. 3. The cartridge 30, which contains therein a plurality of dry analysis elements 10 and sets the dry analysis element necessary for measurement into a biochemical analysis apparatus, comprises an element housing chamber 31 for holding therein the dry analysis elements 10. The element housing chamber 31 includes an element take-out port (not shown) disposed frontward of the lower end of the element housing chamber 31; and a guide hole 35 disposed rearward of the element housing chamber 31 through which a transfer bar (not shown) is inserted. Insertion of the transfer bar into the aforementioned guide hole 35 pushes the lowermost dry analysis element 10 out of the front take-out port for delivery.

The element housing chamber 31 of the aforementioned cartridge 30 has an open top which defines an element charging port for receiving supplementary dry analysis elements, and further has two opposed cutouts 32, 33, which are formed on the opposite two sides of the element housing chamber 31 so as to extend downward respectively from the corresponding two side edges of the element charging port which are substantially identical to the top edges of the analysis element housing chamber 31. The dry analysis element 10 is loaded into the cartridge from the top end of the element housing chamber 31 towards the bottom thereof with the side edges of the dry analysis element being held between fingers. The fingers holding therebetween the dry analysis element 10, enter and move along the aforementioned cutouts 32, 33, such that the dry analysis element 10 can be delivered to the bottom without inversion.

Moisture penetration to the aforementioned dry analysis element changes the measuring characteristics, thereby shortening its effective service life. Thus, an unused dry analysis element 10 is hermetically sealed in a package 11 as shown in FIG. 3. For a relatively compact biochemical analysis apparatus suitable for analyzing a relatively small quantity of samples, it is general practice to unpack more than one kind of individually sealed dry analysis elements 10 one by one from their packages 11, load these elements into cartridges, and place the cartridges in the system.

The dry analysis element 10 has a reagent layer. If the operator touches the reagent layer with his or her finger through a spotting hole 10a in the middle of the element through which the reagent layer is exposed, the measured value can become abnormal. Thus it is essential to avoid touching the spotting hole 10a during handling. Accordingly, special care must be taken not to touch the spotting hole when opening the package 11, and taking the dry analysis element 10 out of the package 11 to load into the cartridge.

Further, in the aforementioned conventional cartridge 30 shown in FIG. 3, the cutouts (vertical slits) 32, 33 are formed in the opposite sidewalls of the element housing chamber 31 for the convenience of loading therein the dry analysis elements 10 in a stacked form, such that each dry analysis element 10 can be introduced into the element housing chamber 31 by entering and moving the fingers along the cutouts 32, 33 with the side edges of the dry analysis element 10 held between fingers. That is, when loading into the cartridge 30, it is necessary to tear open the package 11, take the dry analysis element 10 out of the package 11 with its one end being held between fingers, re-hold the element to grip the side edges of the element, and load the element into the cartridge, all the while taking care not to touch the spotting portion 10a at the center. Since the quantity of the dry analysis elements 10 (i.e., the quantity of the measuring items) necessary for measurement is large, even such a simple procedure increases a burden during the measurement operation.

If the direction of tearing the package which hermetically contains therein a dry analysis element is changed and the direction of taking the dry analysis element out of the package is changed, it becomes possible to load the dry analysis element without shifting the element from one hand to the other. In this case, it is necessary to hold the lateral side edges of the dry analysis element. However, the width between this edge and the spotting hole in the middle of the element is narrow, thereby increasing the risk of touching the spotting hole when holding the element by fingers. From this point of view, it is more desirable to hold the front-back side edges than the lateral side edges when taking the dry analysis element from its package in the conventional way. However, taking out the element in this way requires re-orienting the element between the fingers to load the element into the cartridge.

### SUMMARY OF THE INVENTION

In view of the foregoing, an object of the present invention is to provide an analysis element cartridge that facilitates the operations of unpacking a dry analysis element from its package and loading the element into the cartridge.

According to the present invention, there is provided an analysis element cartridge for containing therein dry analysis elements and setting the elements into an analysis apparatus,

wherein the analysis element cartridge comprises an element housing chamber for holding therein the dry analysis elements which is open at the top thereof, the element housing chamber including: an element charging port defined by the open top of the element housing chamber; and cutouts which are formed on at least two adjacent sides of the analysis element housing chamber so as to extend downward respectively from at least two adjacent side edges of the element charging port which are substantially identical to the top edges of the analysis element housing chamber.

Preferably, the cutouts are formed on three sides of the cartridge. In this case, it is preferable that a post disposed between each adjacent pair of cutouts has a smaller height than the wall with no cutout.

The cutouts serve as paths of the fingers holding therebetween the dry analysis element when loading the dry analysis element into the cartridge.

In accordance with the present invention as mentioned above, cutouts are formed on at least two adjacent sides of the analysis element housing chamber so as to extend downward respectively from at least two adjacent corresponding side edges of the element charging port which are substantially identical to the top edges of the analysis element housing chamber. With this configuration, the dry analysis element can be loaded into the cartridge without re-orienting the element between the fingers, thereby reducing the workload on the operator when the quantity of dry analysis elements to be loaded is large.

In addition, the cartridge which is formed with at least three cutouts in the element charging port enables loading of the dry analysis element into the cartridge with the side edges of the element being held between fingers as in the conventional way.

Further, for the cartridge whose posts, which are defined between adjacent cutouts, are made smaller in height than the wall with no cutout, dry analysis elements can be loaded more easily by abutting the front end of the element against this wall during loading.

### BRIEF DESCRIPTION OF THE DRAWINGS

FIG. 1 is a perspective view showing an analysis element cartridge according to an embodiment of the present invention;

FIG. 2 is a perspective view showing an analysis element cartridge according to another embodiment of the present invention; and

FIG. 3 is a perspective view showing a conventional cartridge with a package for dry analysis elements.

### DESCRIPTION OF THE PREFERRED EMBODIMENTS

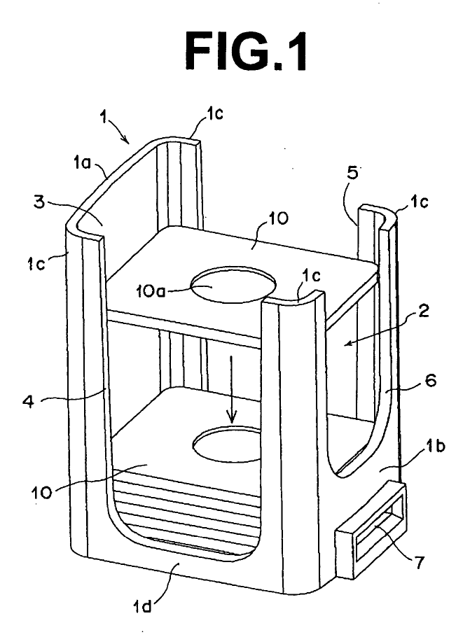

A preferred embodiment of the present invention will be described below with reference to the drawings. FIG. 1 is a perspective view of an analysis element cartridge according to the embodiment of the invention during loading of a dry analysis element. In the present embodiment, cutouts are formed in three side walls.

An analysis element cartridge 1, which is in the form of a rectangular chamber and open at the top thereof, comprises an analysis element housing chamber 2 for holding dry analysis elements 10. The element housing chamber 2 is also open at the top thereof and has an element charging port 3 for receiving supplementary dry analysis elements 10 which is defined by the open top of the element charging port; and cutouts 4-6 which are formed on at least three sides of the analysis element housing chamber 2 so as to extend downward respectively from at least three corresponding side edges (left, right, and rear side edges) of the element charging port 3 which are substantially identical to the top edges of the analysis element housing chamber 2. These cutouts 4-6 serve as paths for fingers holding therebetween the dry analysis elements 10 when loading the dry analysis elements 10 into the cartridge.

The cutouts 4, 5 in the left and right sides are deeper than the cutout 6 in the rear side. The left and right cutouts 4, 5 extend to a bottom wall 1d whereas the rear cutout 6 extends such that a short rear wall 1b remains just below the cutout 6. As a result of forming such cutouts 4 to 6, the element housing chamber 2 is defined by a front wall 1a, the rear wall 1b, posts 1c disposed at four corners of the chamber, and the bottom wall 1d. The rear side posts 1c are formed to be lower than the front wall 1a. Note that it is required that the widths of the cutouts 4, 5, and 6 are set while considering the strengths of the posts 1c.

An element take-out port (not shown), through which only the lowermost one dry analysis element 10 on the bottom wall 1d can pass, is formed in the lower end of the front wall 1a, while a guide hole 7 through which a transfer bar is inserted is formed in the lower end of the rear wall 1b. Inserting the element transfer bar into the guide hole 7 pushes the lowermost dry analysis element 10 out of the front element take-out port. In addition, for the sake of matching with a sample, markings such as a label are positioned on the front surface of the front wall 1a.

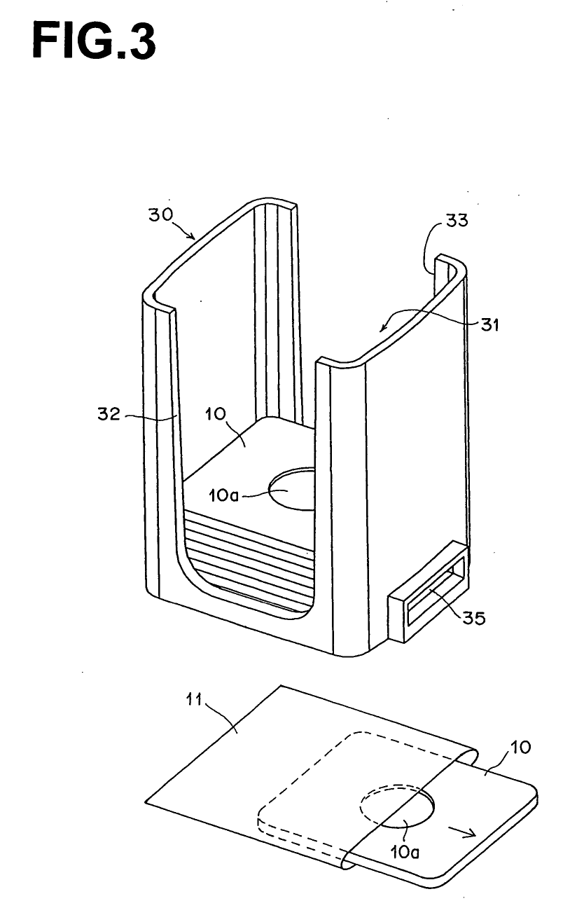

Dry analysis elements 10 are loaded into the aforementioned cartridge 1 by: unpacking a dry analysis element 10 as shown in FIG. 3 from a package 11 while holding the rear end of the dry analysis element 10 between fingers; moving the dry analysis element 10 towards the element charging port 3 on top of the cartridge from the rear side thereof; introducing the dry analysis element 10 into the cartridge from above the rear side posts 1c until the front side edge of the element abuts against the inner surface of the front wall 1a; and moving the element into the lower element housing chamber 2 until it is placed on the bottom wall 1d. Remaining analysis elements are also similarly loaded one by one into the cartridge by repeating the aforementioned steps. In either step, touching of the spotting hole 10a should be avoided. In this loading operation, the fingers holding the rear end of the dry analysis element 10 enter and move along the rear cutout 6.

The dry analysis elements 10 can alternatively be loaded in the cartridge 1 by: holding by fingers the opposites side edge portions of a piece or a stack of dry analysis elements after unpacking and re-orienting them between the fingers, inserting the piece or stack of dry analysis elements into the element housing chamber 2 from the element charging pot 3 at the top of the cartridge 1, moving the piece or stack of dry analysis elements downward until placed on the bottom surface 1d. In this case, the fingers holding the opposite side edge portions of the piece or stack of dry analysis elements 10 enter and move along the left and right cutouts 4, 5.

Subsequently, the analysis element cartridge 1 holding therein the dry analysis elements 10 as mentioned above is set in a sample tray (not shown) of a biochemical analysis apparatus. The sample tray, which may be formed in a circular shape, is loaded with a cartridge 1 in which a sample container containing a sample and a dry analysis element 10 corresponding to a measuring item necessary for the measurement are held in pair. The cartridge 1 is mounted on the circular sample tray with the front wall 1a being positioned on the radially outer side of the tray in order to assure that the marking on the front wall 1a of the cartridge 1 can be seen from outside when the cartridge is loaded.

The lower surface of the dry analysis element 10 is provided with bar codes, dots or the like representing analysis information such as its measuring item. In order to make it possible to read such analysis information with the dry analysis element being held in the cartridge 1, a window is formed in the bottom wall 1d.

A specific embodiment of an analysis element cartridge 1 having cutouts 4 to 6 formed on the three sides (left, right and rear sides) has been described. However, the present invention is not limited to the above embodiment. Such a cutout may be formed also in the front sidewall 1a so that each of the four sidewalls of the cartridge is provided with a cutout.

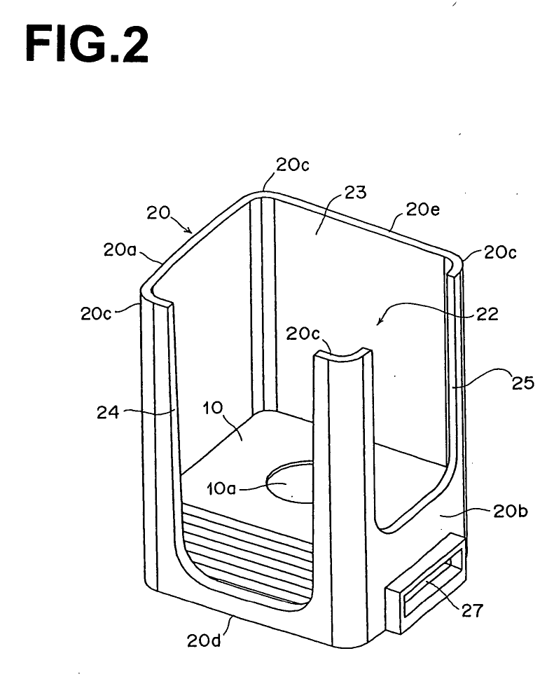

Next, another embodiment of the analysis element cartridge will be described with reference to FIG. 2. In this embodiment, cutouts are provided in two adjacent side walls.

An analysis element cartridge 20, which is in the form of a rectangular chamber and open at the top thereof, comprises an analysis element housing chamber 22 for holding dry analysis elements 10. The element housing chamber 22 is also open at the top thereof and has an element charging port 23 for receiving supplementary dry analysis elements 10 which is defined by the open top of the element charging port; and cutouts 24 and 25, which are formed on the left and rear walls of the analysis element housing chamber 22 so as to extend downward respectively from the left and rear side edges of the element charging port 23. These cutouts 24 and 25 serve as paths for fingers holding therebetween the dry analysis elements 10 when loading the dry analysis elements 10 into the cartridge.

The cutout 24 in the left side is deeper than the cutout 25 in the rear side. The left cutout 24 extends to a bottom wall 20d whereas the rear cutout 25 extends such that a short rear wall 20b remains just below the cutout 25. As a result of forming such cutouts 24 and 25, the periphery of the element housing chamber 2 is defined by a front wall 20a, the rear wall 20b, posts 20c disposed at four corners of the chamber, the bottom wall 1d, and a right side wall 20e.

An element take-out port (not shown), through which only the lowermost one dry analysis element 10 on the bottom wall 20d can pass, is formed in the lower end of the front wall 20a, while a guide hole 27 through which a transfer bar is inserted is formed in the lower end of the rear wall 20b. Inserting the element transfer bar into the guide hole 27 pushes the lowermost dry analysis element 10 out of the front element take-out port. In addition, for the sake of matching with a sample, markings such as a label are positioned on the front surface of the front wall 1a.

Dry analysis elements 10 are loaded into the aforementioned cartridge 20 by: unpacking a dry analysis element 10 as shown in FIG. 3 from a package 11 while holding the rear end of the dry analysis element 10 between fingers; moving the dry analysis element 10 towards the element charging port 23 on top of the cartridge from above; introducing the dry analysis element 10 into the cartridge 20 from above; and moving the element into the lower element housing chamber 22 until it is placed on the bottom wall 20d. Remaining analysis elements are also similarly loaded one by one into the cartridge by repeating the aforementioned steps. In either step, touching of the spotting hole 10a should be avoided. In this loading operation, the fingers holding the rear end of the dry analysis element 10 enter and move along the rear cutout 25.

Note that in the analysis element cartridge 20 of the above embodiment, the cutouts 24 and 25 were provided in the left and rear side walls. However, the cutouts may be provided in any other two adjacent side walls. For example, the cutouts may be provided in the right and rear, the left and front, or the right and front side walls.

What is claimed is:

1. An analysis element cartridge for containing therein a dry analysis element and setting the element into an analysis apparatus, comprising an element housing chamber for holding therein the dry analysis elements,
wherein the element housing chamber is open at the top thereof and comprises:
an element charging port for receiving supplementary dry analysis elements which is defined by the open top of the element housing chamber; and
cutouts which are formed in at least two adjacent sides of the analysis element housing chamber so as to extend downward respectively from at least two adjacent side edges of the element charging port which are the top edges of the analysis element housing chamber.

2. An analysis element cartridge according to claim 1, wherein the downwardly extending cutouts are formed in three edges of the element charging port.

3. An analysis element cartridge according to claim 2, wherein posts defined between adjacent cutouts are formed lower in height than the wall with no cutout.

4. An analysis element cartridge according to claim 1, wherein the cutouts serve as paths for fingers holding therebetween the dry analysis element when the dry analysis element is loaded into the analysis element cartridge.

5. An analysis element cartridge according to claim 2, wherein the cutouts serve as paths for fingers holding therebetween the dry analysis element when the dry analysis element is loaded into the analysis element cartridge.

6. An analysis element cartridge according to claim 3, wherein the dry analysis element is loaded in the cartridge while abutting the front end of the dry analysis element against the wall with no cutout.

7. An analysis element cartridge according to claim 2, wherein the cutouts in the left and right sides are deeper than the cutout in the rear side.

8. An analysis element cartridge according to claim 3, wherein the cutouts in the left and right sides are deeper than the cutout in the rear side.
